(19) United States
(12) Patent Application Publication
(10) Pub. No.: US 2015/0314868 A1
(43) Pub. Date: Nov. 5, 2015

(54) A DEVICE FOR THE GENERATION OF LIFT

(71) Applicant: Angelo Raffaele ALTERIO, Poggiomarino (IT)

(72) Inventor: Angelo Raffaele ALTERIO, Poggiomarino (NA) (IT)

(21) Appl. No.: 14/430,560

(22) PCT Filed: Sep. 26, 2013
(86) PCT No.: PCT/IB2013/058889

§ 371 Date: Mar. 24, 2015

(30) Foreign Application Priority Data
Nov. 8, 2012 (IT) FI2012A000243

(51) Int. Cl. B64C 39/00; B64G 1/40

(52) U.S. Cl. CPC B64C 39/005; B64G 1/409

(57) ABSTRACT

A lift device generating including:
a rotor rotating around a rotation axis, including a plurality of radial tracks with masses slidingly arranged therein so that, following rotation of the rotor, the masses translate by centrifugal force along the tracks towards the rotor periphery;
a stator arranged with respect to the rotor so that, during rotor rotation, the masses projected along the tracks towards the external part of the rotor follow a profile of the stator; the profile of the stator being such that each mass, during rotor rotation, varies its distance with respect to the rotation axis reciprocating along the radial track so that at least a first part of the masses is found at a distance from the rotation axis that is greater with respect to at least a second part of masses so as to create a difference of centrifugal force along a direction.

### TECHNICAL FIELD

The present invention refers to the technical field relative to aircrafts both for atmospheric and space flights.

In particular, the invention refers to an innovative device suitable for generating lift independently of the presence of an air flow.

### BACKGROUND ART

Aircrafts suitable for flying such as planes, of all sizes and performances, and helicopters, have long been known. The operating principle of the flight of a plane is connected to the motion of an airfoil in the air that generates lift. The aircraft is thrust by a propulsor and the lift is a function of the airfoil that is surrounded by air at a pre-determined speed. In particular, important factors are the airfoil (Cl of the wing), the wing surface (S), the speed (V) and obviously the density of the air.

The flight of helicopters is based instead on rotating blades for which, however, the same principle described above rules, that is an airfoil surrounded at a pre-determined speed by a flow.

It is obvious that such a technology is based on a projection principle of the airfoils that is rather complex and that has to consider many factors, first of all the flying conditions. For example, in commercial aircrafts it is frequent that the cruising speeds are near the transonic regime and this involves a big problem as regards safety since the birth of transonic shock waves deviate the flow and cause a loss of lift.

A principle of flight connected to the classical lift of the wing requires a different projection methodology on the basis of the type of flight to which the aircraft is destined, since a wing destined to a supersonic flight must have a completely different airfoil with respect to a wing destined to a subsonic flight since the behavior of the flows are completely different.

It is therefore clear that the classical wings or rotating blades for flights introduce significant projection complications.

Besides, the wing during the flight is subject to air pockets that cause inconveniences and can even be dangerous as far as safety is concerned.

Last, it is known that there obviously exists a maximum limit of height for each aircraft on the basis of the specific wing projection since, as said, the lift is function of the density of the air and when the height increases the air becomes always more rarefied. At heights beyond the ten thousand meters particularly long wings and high speeds are necessary to provide for the low density of the air.

Documents are known, such as DE102010006197, which describes a device provided with rotating masses on a curved path. Such a device is not structured to be able to generate a lift and result applicable to an aircraft but instead serves for the generation of energy. In the same manner, documents OA9176 and DE102008010881 can only produce energy but not lift.

Such documents describe the preamble of claim 1.

### DISCLOSURE OF INVENTION

It is therefore the aim of the present invention to provide a device for the generation of lift that solves all said technical inconveniences.

In particular, it is the aim of the present invention to provide a device that results structurally simple and absolutely independent from its shape and from the contact with the air for the generation of the lift in such a way as not to be affected either by the height or, even less, by the air pockets or other factors such as heavy rain.

These and other aims are reached with the present device for the generation of lift for an aircraft, in accordance with claim 1.

In accordance with the invention, the present device (1) for the generation of lift for an aircraft comprises:
A rotor (2′, 2″) rotatable around a rotation axis (4) and provided with a plurality of radial tracks (10) in which masses (15) are slidingly arranged so that, following the set in rotation of the rotor, said masses translate by centrifugal force along said tracks towards the periphery of the rotor;
A stator (3) arranged with respect to the rotor in such a way that, during the rotation of the rotor, the masses projected along the tracks towards the external part of the rotor are constrained to follow a profile (18) of the stator (3);
And wherein the profile (18) of the stator is such that each mass (15), during the rotation of the rotor, varies its distance with respect to the rotation axis (4) of the rotor reciprocating along the radial track (10) in such a way that at least a first part of the masses is found at a distance (d1) from the rotation axis (4) that is greater with respect to the distance (d2) occupied by at least a second part of masses so as to create a difference (Δ) of centrifugal force (F) along a direction.

In accordance with the invention, the rotor foresees at least a disc (2′, 2″) rotatable around said axis (4) and provided with said plurality of radial tracks (10) on which the masses can slide. In addition, the masses (15) and the arrangement of the tracks are such that said difference (Δ) of centrifugal force (F) along said direction determines a lifting force of the aircraft to which the device (1) is applied, once a pre-determined minimum threshold value of rotation speed of the disc has been reached.

The present invention allows the reaching of all the pre-fixed aims.

In particular, the device thus realized generates lift in an independent manner from a profile surrounded by an air flow. The lift is now simply generated by taking advantage of a difference of centrifugal force obtained by obliging sliding masses to follow a pre-established path that varies the distance from the rotation axis 4. This simple solution, therefore, does not only generate lift but it is also capable of obtaining horizontal forces with a simple manoeuvre of orientation of the stator by means of a system of levers commanded by the driver of the aircraft.

The aircrafts provided with such a device are not affected by air pockets anymore. The same device lends itself well to space flights and complex propulsory that require a significant fuel consumption are not requested.

Further advantages can de deduced from the dependent claims.

### BRIEF DESCRIPTION OF DRAWINGS

Further features and advantages of the present device for the generation of lift, according to the invention, will result clearer with the description that follows of one of its preferred embodiments, made to illustrate but not to limit, with reference to the annexed drawings, wherein:

Figures from 1 to 3 show in an axonometric view the present invention;

FIG. 4 shows details in a top view of the stator highlighting the bushing 30 for the application of the bearings and the edge 18 that in fact forms the guiding track of the centrifugal masses applied to the disc;

FIG. 4-BIS shows details of the shape of the stator, schematizes its connection to the shaft 4 and shows a control lever 44;

FIG. 5 shows the rotor with the notches forming the radial tracks;

FIG. 6 shows in lateral section the assembly mounted;

FIG. 7 extrapolates the single mass, for example in the shape of a trapezoid, sliding inside the notch;

FIG. 8 shows one of the two discs forming the rotor and highlights the notches (twelve in all, every 30° of angular opening) inside of which the masses are slidingly applied;

FIG. 9 shows one of the two stators and highlights the hole 20 through which it is fixed on the rotation axis in an idle manner. The other holes are just of structural lightening and can also be not present;

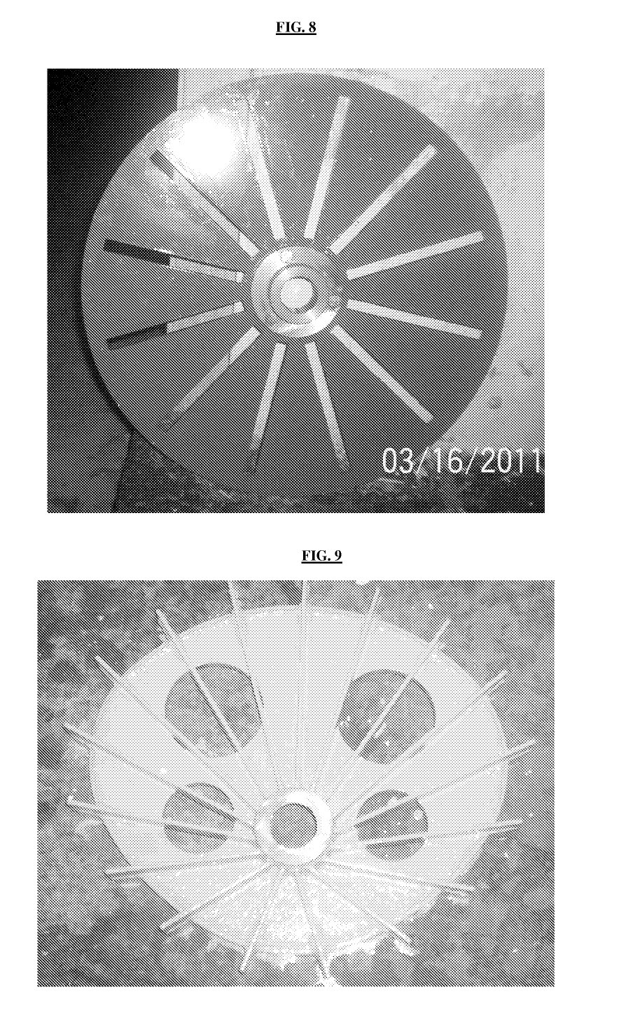

FIG. 10 shows a possible realizative variant;

FIG. 11 shows a schematization of the device applied on an aircraft and its generation of lift in such a way as to lift the aircraft;

FIG. 12 shows an alternative arrangement, that is with the motor (M) not in axis with respect to the device and connected to this last one through appropriate gears.

### DESCRIPTION OF A PREFERRED EMBODIMENT

FIG. 1 describes the device for the generation of lift 1. The device foresees a rotation axis 4, for example a shaft, around which a rotor 2 is mounted rotatably.

The rotor, as for example well highlighted in FIG. 2, is formed by two discs (2′, 2″) splined to the rotation shaft′4 in such a way that the rotation of the shaft 4 drags in rotation integrally said two discs.

Always as well highlighted in FIG. 2, the two discs (2′, 2″) are spaced between them of a pre-determined “gap”. Such a “gap”, as described right below, serves to allow an arrangement of sliding centrifugal masses with respect to the two discs.

Preferably, said distance between the two discs is of between 50 mm and 60 mm and, better still, of 55 mm. The distances indicated above are those optimal to avoid excessive stresses of flexion and cut on the driving shaft, of torsion on the discs of the stator and of the rotor, which could determine a breakage.

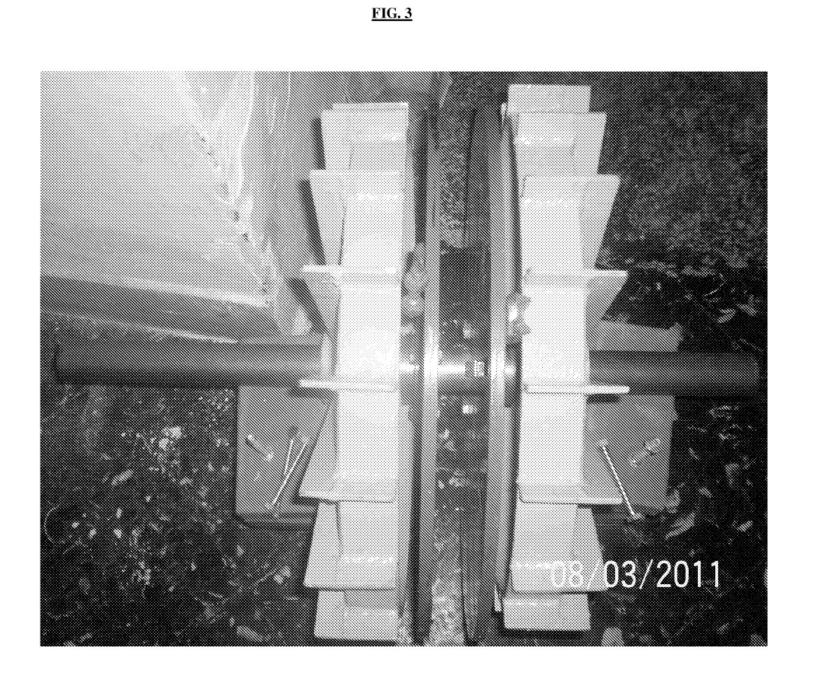

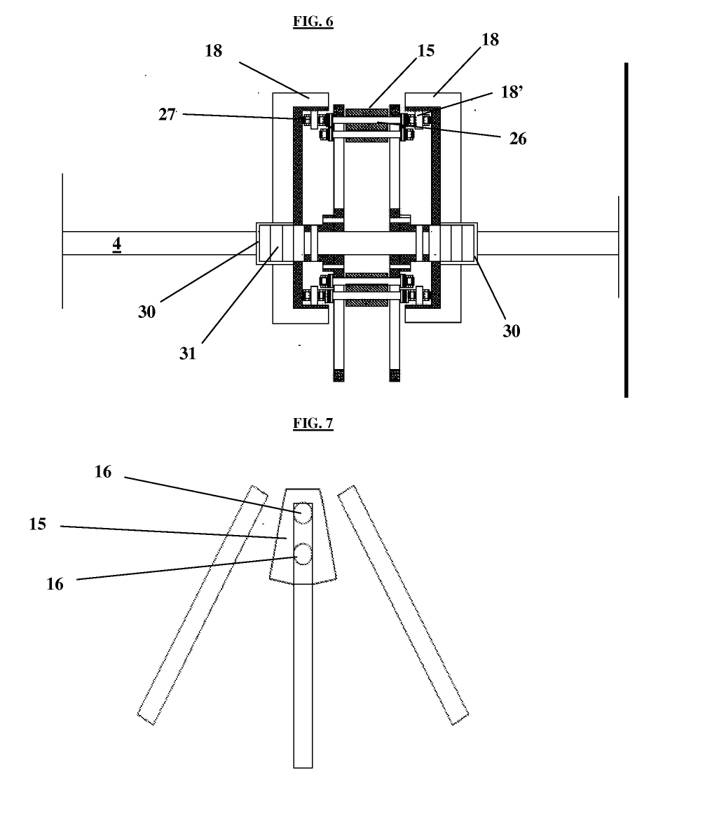

FIG. 5 and FIG. 8 highlight well a disc which is preferably of a circular shape in such a way that during its rotation it results balanced.

The disc presents then a plurality of radial notches 10, for example of rectangular shape, which extend radially according to a direction that goes from the splining point 5 of the shaft 4 towards the external perimeter (circumference of the rotor). The notches are preferably arranged with an angular spacing, between a notch and the subsequent one, of 30°, therefore for an overall number of twelve notches. This number, as discussed below, optimizes the lift effect.

The notches, independently of the number, are preferably arranged in such a way that the rotor presents a circular symmetry, that is a symmetry with respect precisely to the rotation axis 5. This results in the system being well balanced.

Obviously, a different angular spacing can be selected, preferably always symmetrical, without for this moving apart from the present inventive concept.

Inside each single rectangular opening, along which the axes supporting the centrifugal masses slide, spools can be arranged that, with a similar function to that of the ball bearings, reduce to the minimum the energy dispersed due to friction during the sliding of the masses and at the same time reduce the wear of such rectangular lodgings realized on the two discs constituting the rotor.

The two discs 2′ and 2″ are identical between them and splined to the axis in such a way that a radial notch of a disc finds its corresponding one in the opposite disc (see for example FIG. 2).

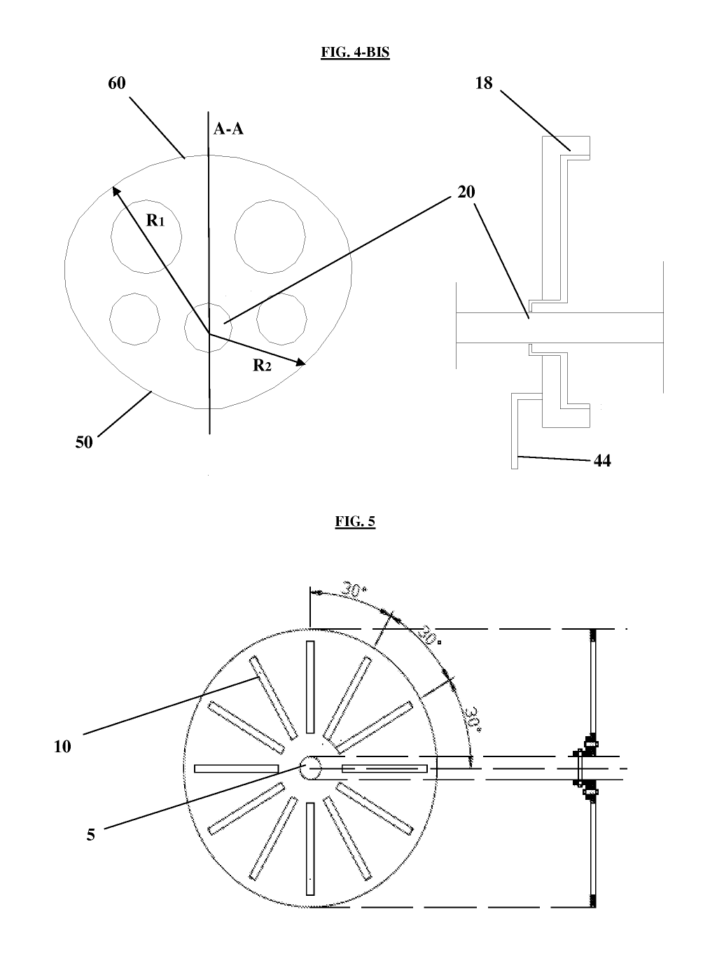

FIG. 7 schematizes then, just as a way of example, three adjacent notches of a disc and shows a centrifugal mass 15 mounted inside a notch. The mass is sliding inside the notch through one or more pivots 16 that are inserted slidingly in the notch. In order to bind the mass in such a way that it does not exit from the notch, the notch is realized passing through the thickness of the disc in such a way that the pivot that exits from one of its ends, from the opposite part of the notch, can be bound through the screwing of a nut and lock nut. This solution facilitates above all the assembly and disassembly of the centrifugal mass.

The mass can obviously be realized in any material, such as for example steel.

Going on with the description of the preferred embodiment of the invention, for example with reference to FIG. 3, the “gap” is well highlighted between the two discs (2′, 2″). Inside the “gap” on each track a centrifugal mass 15 is mounted that is bound on one part to a notch of the disc 2′ and on the apposite part to the corresponding notch of the disc 2″.

Each mass (twelve in all) is free to slide along the notches inside the “gap”. When the disc rotates at a pre-determined rotational speed a centrifugal force is generated which tends to make the masses slide towards the periphery of the disc, bringing them to the end of the notch.

It is here reminded that the centrifugal force is directly proportional to the mass (m), to the square of the angular speed and to the distance (r) from the rotation axis. The greater the distance from the rotation axis is, the greater the centrifugal force acting on the mass in question will be.

Going back to figures from 1 to 3, it is then shown a stator 3 which is arranged idle with respect to the rotation axis 4. In this regard, when the shaft 4 rotates and drags in rotation the rotor 2, the stator remains still instead.

The stator 3, as for example shown in FIG. 2 and in FIG. 3, is formed by a first stator 3′ that faces the first rotor 2′ and by a second stator 3″ that faces the second rotor 2″.

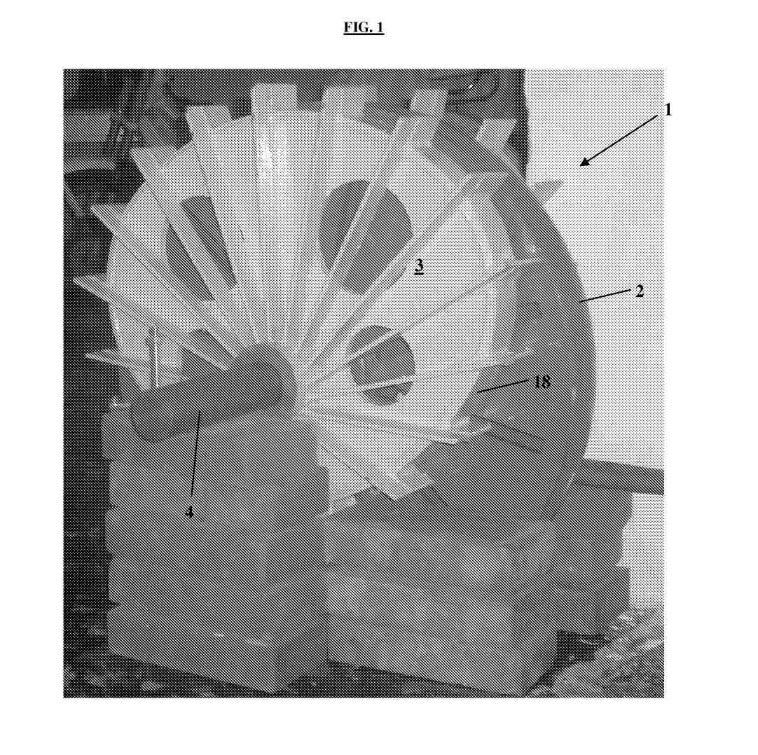

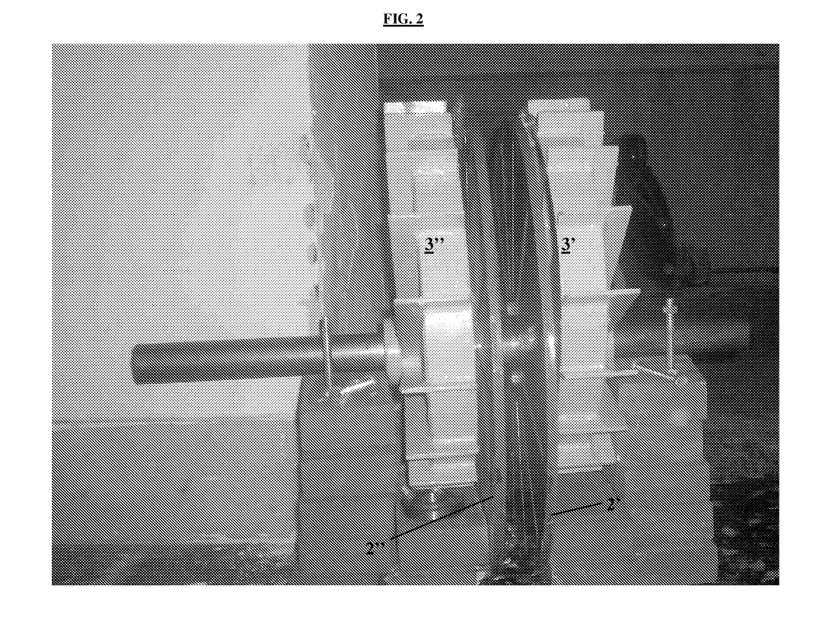

FIG. 4 and FIG. 4-BIS show well in detail a single stator structurally.

In particular, the figures show a disc of the oval type and having a hole 20 for its idle fixing around the rotation axis through a bushing 30 and relative bearings.

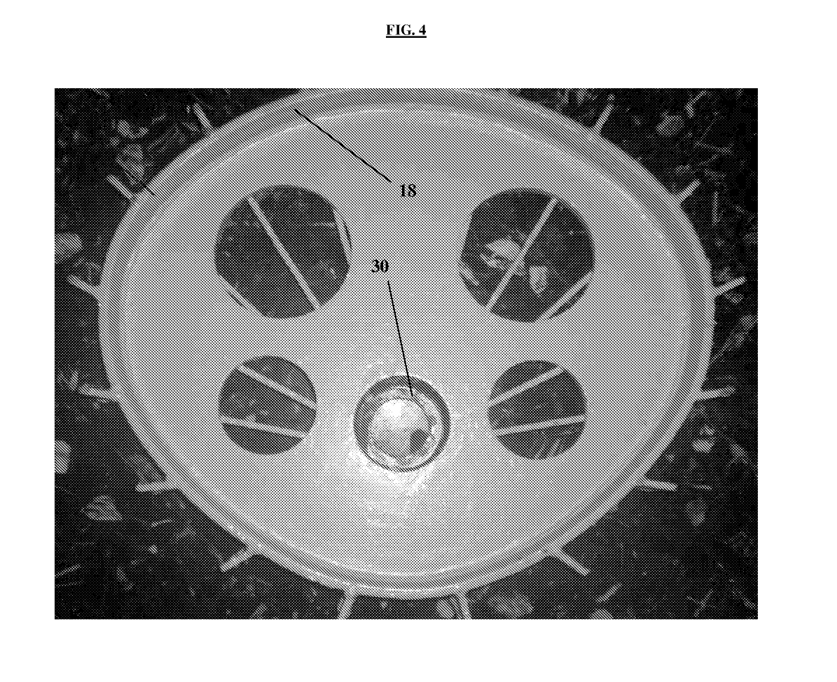

In particular, in the preferred embodiment of the invention and with reference to FIG. 6, with number 30 the bushing is highlighted that is fixed to the hole 20 of the stator (for example through a fixing pin, welding or also by mechanical interference). With number 31 are instead indicated explicitly the rolling bearings mounted on the shaft 4 and that go in rolling contact against the bushing 30 (for example four bearings per part). In this way, the shaft rotates with respect to the stator that remains fixed. The pre-chosen angular position of the stator with respect to the rotor is obtained through a fixed connection of the stator to a structural part of the aircraft or, as highlighted in FIG. 4, through a manoeuvring lever 44 controllable by the pilot and that allows to rotate according to pre-determined angulations the stator with respect to the rotor to then keep it in the pre-chosen position. In this way, the stator keeps fixed the position with respect to the rotor and in particular the solution using a lever allows to adjust the direction of movement of the aircraft in the vertical plane, making the stator rotate as necessary at a new angulation to then keep the new pre-chosen position fixed.

FIG. 4-BIS shows a possible plane of symmetry A-A for the stator and highlights that it is a variable radius one (R) (radius R1 different from radius R2).

In particular, the radius progressively diminishes while it sweeps the belly part 50 of the stator to then progressively increase when it sweeps towards the back part of the stator.

Obviously, as clarified in the explanation below, it is not necessary that there is a progressive variation. It is important that the stator presents a belly part with a distance from the axis 20 inferior to that of the back. Basically, the stator, either of oval shape or of policentrical shape, is always of asymmetric shape with respect to the horizontal axis but symmetrical with respect to the vertical axis.

As always highlighted in FIG. 4-bis, the stator presents an internal lip or binary 18 (preferably orthogonal to the plane of the stator) whose aim is that of creating a bond to the sliding of the masses in the notches when the stator is arranged in front of its respective disc (see for example FIGS. 1, 2 and 3).

FIG. 1 shows very clearly how a stator that faces the rotor creates, thanks to the lip 18, a sliding bond for the masses, since the mass is arranged in each notch with a fixing leg that exceeds from the notch and that projects towards the lip from the part of the stator. It is then foreseen a bearing that rolls without friction on the internal binary of the stator.

For example, FIG. 6 shows clearly a fixing mode of each centrifugal mass 15 arranged in the gap and fixed slidingly on two opposed notches. The pin 26 exceeds from the two notches opposed on the part directed to the stator and is blocked by a nut 27 and lock nut that does not impede the eliding along the notch but impedes instead that the pin exits laterally from the notch. The nut 27 goes in contrast against the lip 18, therefore the lip 18 of the stator defines a variable radius perimeter, with respect to the rotation axis 4, which delimits a stop of the notches (see FIG. 1). FIG. 6 clearly shows a rolling sphere 18′ that minimizes the effects of rubbing friction that are generated during the rolling.

During the rotation of the rotor each notch will therefore be delimited by the particular profile of the fixed stator that intercepts.

FIG. 1 clearly shows the variation of radius R of the stator with respect to its fixing axis to the shaft 4.

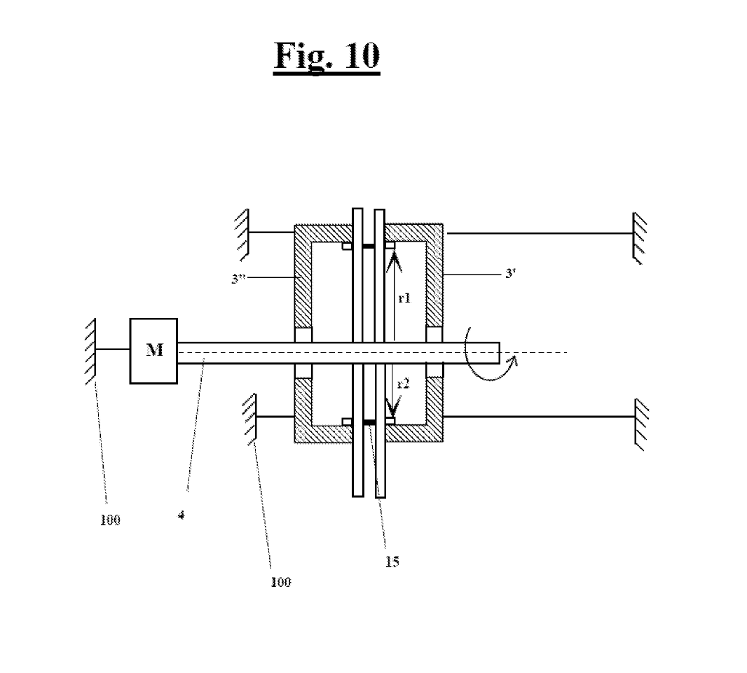

FIG. 10 shows a further variant, identical to the preceding one except for the fact that the stator is fixed with respect to the rotatable discs through a fixed bond to a structure (for example that of the aircraft where the present device is applied) and with passing hole that allows the insertion of the shaft 4 with clearance. With the letter M the motor is indicated that conducts in rotation the shaft 4 which is splined to the rotor that foresees the sliding masses 15 described above.

Also as in the preceding one, the stator is therefore idle with respect to the axis 4. The figure represents, just as a way of example, two masses that are diametrically opposed and of which one is placed at a distance of radius (r1) that is greater than the radius (r2).

In use, therefore, it functions as follows.

An external motor puts the shaft 4 in rotation at a pre-determined speed. The motor can be of any nature: electric one, internal combustion one, nuclear fission one (by motion in the inter-planetary space), etc.

The motor brings the two discs of the rotor (2′, 2″) at such a rotation speed that the centrifugal masses, under the action of the centrifugal force, move along the radial notches towards the external part of the rotor.

The rotation speed can be any and is dimensioned on the basis of the centrifugal masses chosen and on the lift force that wants to be generated. The dimensioning is therefore not limiting for the present invention.

Once a pre-determined rotation speed has been reached, the centrifugal masses are projected towards the external part of the rotor, sliding along the notches. If the stator were not there, then, at regime state, the rotor would rotate with the masses that are all in position of stop of the notches from the part of the external perimeter of the rotor.

The presence of the stator, however, obliges the centrifugal masses, during the rotation of the rotor, to follow the profile of the stator (see for example FIG. 6).

Taking into examination for simplicity purposes a single centrifugal mass, during a rotation of 360° of the rotor, said mass reciprocates (oscillates) inside the notch because bound by the stator. In particular, the centrifugal force tends to expel the centrifugal mass which however at each rotation angle finds the lip 18 that forms a variable radius perimeter. This perimeter, for example as shown in FIG. 1, obliges the single mass to come near to the axis 4 when it is sweeping the belly part of the stator and then allowing it to move apart from the axis 4 when it initiates to sweep the back part of the stator that has a greater radius than the rotation axis.

Existing central or rotational symmetry, FIG. 5 clearly shows how each notch has a diametrically opposite corresponding one. The overall effect, thanks to such a symmetry, is therefore that during each rotation the masses present in the notches that pass by the back 60 of the stator will be positioned at a distance from the axis 4 that is greater with respect to the masses that transit by the belly 50. Each mass in the back has a correspondent one with the masses in the belly.

This difference of distance therefore creates a difference of the vertical components of the centrifugal forces generated by the twelve masses and therefore a resultant which is oriented upwards, therefore generating a lift that lifts the device.

It is obvious that according to the position of the stator, established by the driver of the aircraft, a single resulting vertical force can be obtained with precision, or general oblique forces in the vertical plane.

It is also obvious that the configuration of the invention describes a symmetrical device for balancing questions, that is two rotor discs and two stators.

The mass in the gap is one per notch and fixed to the ends but nothing would impede a single mass fixed to the right rotor and a single mass fixed to the left rotor always inside the gap.

The stator can also be realized in such a way as to be adjusted rotationally in a pre-chosen position. If, for example, it is fixed in the position of FIG. 4, the result is that a perfect vertical force is generated. If the stator is rotated of some degrees on one part or on the other, and then fixed, the result will be that the resulting force is inclined and generates a vertical component and a horizontal component. This allows to obtain forces for advancing, apart from lift. This operation is, as said, executable by the pilot through the leverage 44.

It is also obvious that the present invention lends itself well to a connection of more of said devices either in series or in parallel to increase the lifting force.

There follows a lift calculation obtained with the present device:

$$P ( lift ) = \frac{4 {π}^{2} \cdot {n}^{2} \cdot m}{9 , 81 * 3600} [ Δ {D}_{1} + Δ {D}_{3} + \sqrt{3} * Δ {D}_{2} ] ;$$

n=800 turns/min;

m=single centrifugal mass=1.9 Kg;

π=3.14;

ΔD₁=difference between the useful radii of two vertical slots of the rotor=13.5 cm;

ΔD₂=difference between the useful radii of two opposite slots of the rotor inclined of 30° on the vertical=13, 0 cm;

ΔD₃=difference between the useful radii of two opposite slots of the rotor inclined of 60° on the vertical=11.5 cm;

ΔD₁,ΔD₂,ΔD₃ depend on the shape and on the sizes of the stator.

Calculations made, the following is obtained:

P=650 Kp=6376.5 N;

It is easy to verify that if the number of turns of the rotor is equal to 1500 turns/minute the lift is equal to:

P=2270 Kp=22.269 N;

If the symmetry axis of the stator is inclined of 30° on the vertical, the horizontal traction force of the aircraft is given by the horizontal component of the Coriolis force, and is equal to 2270*sen 30°=0.5*2270 Kp=1135 Kp, to which corresponds an acceleration of the Coriolis apparatus equal to:

$$a = \frac{F}{m} = \frac{1135 * 9.81}{250} = 44.5 \frac{m}{{sec}^{2}} = 160 \frac{Km}{h sec}$$

Being the overall weight of the aircraft equal to about 250 kp.

This means that the aircraft, in a vacuum, approximately after 20 seconds reaches a cruising speed of 3200 Km/h.

We calculate the necessary power that the motor must have, for the prototype in question.

Considering a peripheral force of 50 Kp necessary to beat all the frictions for the rotation of the motor, it follows that the power P that the motor must have is equal to:

$$\frac{50 * 9.81 N * 0.20 m * 2 * 3.14 * 1500 girl}{60 sec * 1000} = 23 , 10 Kw = 23 , 10 * 1 , 341 Hp = 31 Hp$$

The motor must therefore have, in this case, a power of about 30 horses, that is about 25 Kw.

The manual rotation of the two discs constituting the stator, in the vertical plane, through two levers (integral between them) and adjusted by the driver of the aircraft by means of a system of levers commanded by the driver, allows to obtain a horizontal component of the lift that determines a horizontal displacement of the aircraft.

The manual rotation of the stator, in the vertical plane, by means of two levers fixed on the chassis and with two pins or a system of levers commanded by the driver, allows to obtain a horizontal component of the lift that determines a horizontal displacement of the aircraft.

A rotation of the apparatus, then, around a vertical axis allows the aircraft to move in a direction or in the opposite one of the azimuth plane.

Although in the present description, for simplicity purposes, the gravity force and rubbing frictions have not been considered, it is obvious that such a size of the device (therefore of centrifugal masses, rotation speed, etc.) can be easily selected so that lift is generated despite dissipation due to frictions and obviously considering the gravity force. In particular, it is easily implementable a routine calculation of masses, rotation speed of the rotor, arrangement of the cuts so as to generate a lift sufficient to beat the weight P of the aircraft where such a motor is applied in an ordinary flight.

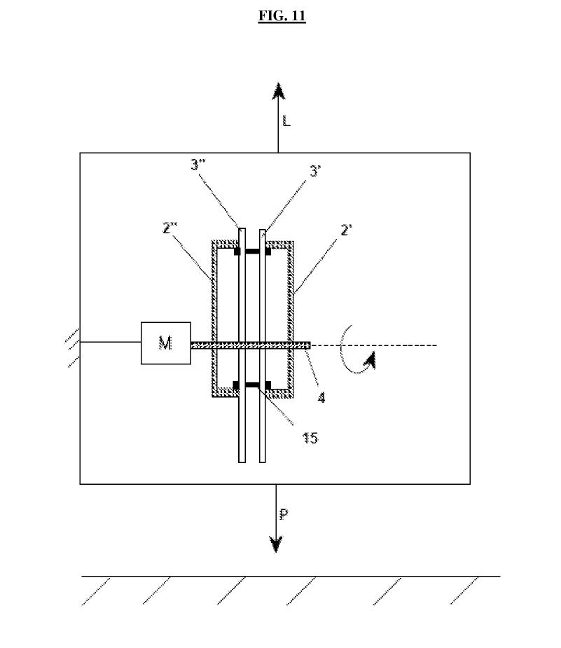

FIG. 11 shows a physical scheme of operation with a main schematization of the forces. The device, fixed for example to the aircraft in one or more points, generates a lift (L) that can be selected, for example, by varying the rotation speed of the rotor on the basis of the masses applied and of the arrangement of the tracks, in such a way as to beat the weight force (P) and initiate the lifting exactly like a normal helicopter. The internal forces to the system, that is centrifugal force acting on the masses and centripetal force that binds the masses in the relative position, are obviously balanced but the system, with respect to the floor inertial reference, is not on the whole balanced and is lifted when the lift that is generated exceeds the weight force of the aircraft.

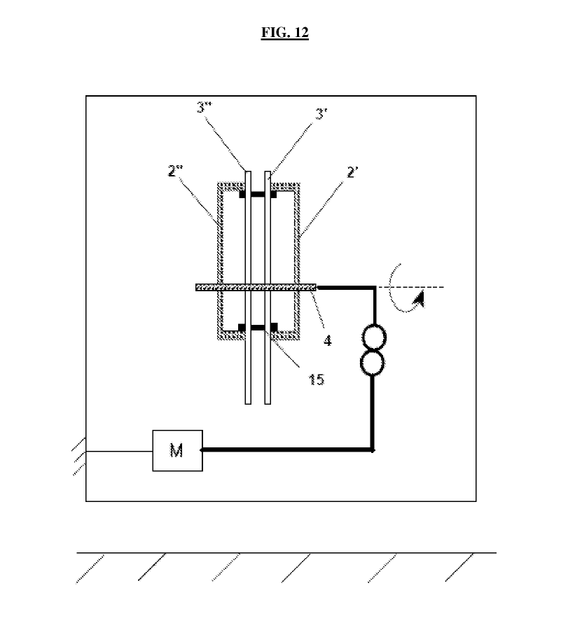

FIG. 12 instead shows a variant in which the motor can be misaligned with respect to the device and connected to it with appropriate transmission gears schematized in figure.

1. A device (1) for the generation of lift for an aircraft and comprising:
A rotor (2′, 2″) rotating around a rotation axis (4) and provided with a plurality of radial tracks (10) inside of which masses (15) are slidingly arranged so that, following the set in rotation of the rotor, said masses translate by centrifugal force along said tracks towards the periphery of the rotor;
A stator (3) arranged with respect to the rotor in such a way that, during the rotation of the rotor, the masses projected along the tracks towards the external part of the rotor are bound to follow a profile (18) of the stator (3);
And wherein the profile (18) of the stator is such that each mass (15), during the rotation of the rotor, varies its distance with respect to the rotation axis (4) of the rotor reciprocating along the radial track (10) in such a way that at least a first part of the masses is found at a distance (d1) from the rotation axis (4) that is greater with respect to the distance (d2) occupied by at least a second part of masses so as to create a difference (Δ) of centrifugal force (F) along a direction;
characterized in that the rotor foresees at least a disc (2′, 2″) rotatable around said axis (4) and provided with said plurality of radial tracks (10) on which the masses can slide, the masses (15) and the arrangement of the tracks being such that said difference (Δ) of centrifugal force (F) determines a lifting force for the aircraft to which to apply said device (1) when a pre-determined minimum threshold value of rotation speed of the disc is reached.

2. A device (1), as per claim 1, wherein the stator (3) is fixed.

3. A device (1), as per claim 1, wherein the stator (3) is controllable in such a way as to make it rotate of a pre-determined angle with respect to the rotatable disc (2) and then fix it in the pre-chosen angular position.

4. A device, as per claim 3, wherein a leverage (44) is foreseen, connected to the stator and through which the angular position of the stator with respect to the disc is fixed and controlled.

5. A device (1), as per claim 1, wherein the radial tracks (10) in the disc are arranged in such a way that the disc has a central symmetry with respect to its rotation axis (4).

6. A device, as per claim 5, wherein twelve tracks are foreseen in the disc spaced angularly one from the other of an angle of 30°.

7. A device, as per claim 1, wherein the tracks are in the shape of a rectangular notch of a pre-determined length and width and that run through the entire thickness of the disc.

8. A device, as per claim 1, wherein a first (2′) and a second disc (2″) are foreseen fixed to a rotation shaft (4) spaced between them in such a way as to form a “gap” into which the centrifugal masses are slidingly fixed.

9. A device, as per claim 8, wherein the stator (3) comprises a first (3′) and a second stator (3″), respectively, which face the first (2′) and the second disc (2″).

10. A device, as per claim 1, wherein the stator (3) comprises a lip (18) that faces the disc and defines a binding perimeter for the sliding of the masses during the rotation.

11. A device, as per claim 1, wherein means (M) are foreseen for setting in rotation the rotor at such an angular speed that the masses are projected in contact against the profile of the stator during the rotation.

12. A device, as per claim 11, wherein said means (M) foresee a motor that conducts in rotation a shaft (4) splined to the disc.

13. A device, as per claim 1, wherein the stator (3) has a transversal axis (A-A) of symmetry.

14. A device, as per claim 1, wherein the profile of the stator has such a shape that said first part of the masses and said second part of masses during a rotation are in diametrically opposite positions between them.

15. A device, as per claim 14, wherein said two diametrically opposite positions are such as to allow obtaining a vertical resultant of lift.

16. A device, as per claim 1, wherein a mass for each track (10) is foreseen.

17. A device, as per claim 1, wherein the masses are all equal in weight among them.

18. An aircraft characterized in that it comprises one or more devices as per claim 1.
